(19) United States
(12) Patent Application Publication
(10) Pub. No.: US 2016/0132637 A1
(43) Pub. Date: May 12, 2016

(54) NOISE MODEL TO DETECT COPY NUMBER ALTERATIONS

(71) Applicant: Case Western Reserve University, Cleveland, OH (US)

(72) Inventors: Vinay Varadan, Cleveland, OH (US); Kishore Guda, Cleveland, OH (US)

(21) Appl. No.: 14/939,363

(22) Filed: Nov. 12, 2015

Related U.S. Application Data
(60) Provisional application No. 62/078,572, filed on Nov. 12, 2014.

(51) Int. Cl. G06F 19/22; G06F 19/24

(52) U.S. Cl. CPC G06F 19/22; G06F 19/24

(57) ABSTRACT

This disclosure relates to systems and methods that employ a noise model generated from control samples to detect copy number alterations (CNA) in one or more test samples. The noise model can be generated to represent an indication of noise associated with chromosomes of control biological samples obtained via a common protocol. The indication can be determined by comparing chromosomes of the control biological samples. The noise model can be used to detect CNAs within the test sample by analyzing variability thereof with respect to the noise model.

### RELATED APPLICATIONS

This application claims the benefit of U.S. Provisional Application No. 62/078,572, filed Nov. 12, 2014 entitled “NOISE MODEL AND DETECTION OF COPY NUMBER ALERATIONS.” The entirety of this provisional application is hereby incorporated by reference in its entirety for all purposes.

### GOVERNMENT FUNDING

This invention was made with government support under contracts CA148980 and CA150964 awarded by the National Institutes of Health. The United States government has certain rights to the invention.

### TECHNICAL FIELD

This disclosure relates to systems and methods that employ a noise model generated based on control samples to detect copy number alterations (CNA) in one or more test samples.

### BACKGROUND

Human cancer is caused in part by structural changes resulting in DNA copy number alterations (CNA) at distinct locations in the tumor genome. Identification of such CNAs in tumor tissues has contributed significantly to both the understanding of disease etiology (e.g., pathogenesis or progression) and the expansion of therapeutic avenues across multiple cancers. However, current detection techniques suffer from limitations, which limit the reliability of the current detection techniques in clinical and research settings.

Traditionally, CNAs have been detected using cytogenic techniques, such as fluorescent in situ hybridization, array comparative genomic hybridization, and representational oligonucleotide microarrays, as well as single nucleotide polymorphism (SNP) arrays. However, each of these traditional techniques is limited with regard to the number, resolution, and platform-specific accessibility of regions that can be interrogated in the genome. More recently, massively parallel sequencing technologies have provided the ability to comprehensively characterize genome-scale DNA CNAs in tumor tissues. In particular, whole-exome sequencing (WES) offers a cost-effective way of interrogating mutation and copy number profiles within protein-coding regions in the tumor genome. This has resulted in the increasing use of WES in both research and clinical settings. However, detecting CNAs in WES data can be challenging at least due to the non-trivial selection of algorithm-specific parameters due to variability in tumor content among clinical samples, as well as random technical variability in DNA library enrichment.

### SUMMARY

This disclosure relates to systems and methods that employ a noise model generated based on control samples to detect copy number alterations (CNA) in one or more test samples. The systems and methods can detect CNAs across diverse disease types and sequencing platforms robustly without requiring complex parameter choices or user intervention.

According to one example, a method is described. At least a portion of the acts of the method can be performed by a system comprising a processor (e.g., a processing core, a processing unit, or the like). The method includes accessing control data stored in a non-transitory memory for a plurality of biological samples. The control data for each of the biological samples can be obtained via a common protocol. Data related to each of a plurality of chromosomes within the control data can be compared to determine an indication of noise that is inherent in the protocol used to obtain the sequencing data. A noise model representing the identified noise associated with each of the plurality of chromosomes can be generated, and the noise model can be used to detect CNAs within at least one test sample obtained according to the protocol.

According to another example, a system is described. The system can include a non-transitory memory storing machine-readable instructions and a processing unit to access the non-transitory memory and execute the machine-readable instructions. The machine-readable instructions can include a retriever to access control data stored in the non-transitory memory for a plurality of biological samples. The control data for each of the biological samples is obtained via a common protocol. The machine-readable instructions can also include an identifier to compare a plurality of chromosomes within the control data to determine an indication of noise associated with each of the plurality of chromosomes that is inherent in the common protocol used to obtain the sequencing data. The machine-readable instructions can further include a model generator to generate a noise model representing the indication of noise associated with each of the plurality of chromosomes. The noise model can be used to detect CNAs within at least one test sample obtained via the protocol by analyzing variability thereof with respect to the noise model.

According to a further example, a method is described. At least a portion of the acts of the method can be performed by a system comprising a processor (e.g., a processing core, a processing unit, or the like). The method includes receiving at least one test sample and comparing the at least one test sample to a noise model. The noise model can be constructed based on control data from a plurality of biological samples obtained via a common protocol. The noise model can identify noise associated with each of a plurality of chromosomes in the control data that is inherent in the protocol used to obtain the sequencing. CNAs in the one or more test samples can be identified based on the comparing, and data related to the identified CNAs in the at least one sample can be output.

According to still another example, a system is described. The system can include a non-transitory memory storing machine-readable instructions and a processing unit to access the non-transitory memory and execute the machine-readable instructions. The instructions can include a receiver to receive test sequencing data for at least one test sample. The instructions can also include a calculator to estimate segmental Log Ratios from pairwise disease-normal comparisons of segments of the test sequencing data produced from at least one disease sample and normal biological samples obtained according to a common protocol. The instructions can also include an evaluator to identify copy number alterations (CNAs) in the sequencing data of the disease sample based on applying a noise model with respect to the estimated segmental LogRatios, the noise model characterizes chromosome-specific noise thresholds associated with each of a plurality of chromosomes that is inherent in the protocol used to obtain the test sequencing data. An output can provide output data related to the identified CNAs in the test sequencing data.

### BRIEF DESCRIPTION OF THE DRAWINGS

FIG. 1 illustrates an example of a system that detects copy number alterations (CNA) in test sample data.

FIG. 2 illustrates an example of the noise model generation unit in FIG. 1.

FIG. 3 illustrates an example of the identifier in FIG. 2.

FIG. 4 illustrates an example of the CNA detection unit in FIG. 1.

FIG. 5 illustrates an example of the comparator in FIG. 4.

FIG. 6 illustrates an example of a clinical diagnostic use of the system in FIG. 1 to detect CNAs in a disease sample from a patient.

FIG. 7 illustrates an example of a research use of the system in FIG. 1 to detect CNAs in a test population.

FIG. 8 illustrates an example of a method for detecting CNAs in test sample data.

FIG. 9 illustrates an example of a method for generating a noise model.

FIG. 10 illustrates an example of a method for CNA detection using the noise model.

This application includes an Appendix that forms an integral part of this application and includes additional FIGS. 11-16.

### DETAILED DESCRIPTION

This disclosure relates to systems and methods that employ a noise model generated based on control samples to detect copy number alterations (CNA) in at least one test sample. The systems and methods can detect CNAs in the at least one test sample without requiring parameter choices or user intervention. In some examples, the term CNA can refer to somatic CNAs that affect at least a portion of an animal or plant body. Generally, a CNA is an alteration of the DNA of a genome that results in a cell having an abnormal number of copies of one or more sections of the DNA. For example, CNAs can correspond to relatively large regions of the genome that have been deleted (fewer than the normal number) or added (more than the normal number) on certain chromosomes. In some examples, CNAs can be used to detect, diagnose, or study a given disease (a pathological condition of a living animal or plant body or one of its parts that impairs normal functioning and is typically manifested by distinguishing signs and symptoms). Examples of diseases or disease states that can exhibit CNAs include cancer (e.g., various tumors), psychiatric disorders (e.g., autism, Schizophrenia, etc.), autoimmune diseases (e.g., lupus), and neurological disorders (e.g., Alzheimer's disease, Parkinson's disease, etc.) to name a few.

The test samples analyzed by the systems and methods of this disclosures can include sequencing data that can be profiled to measure the activity (or expression) of thousands of genes at once, to create a global picture of cellular function. For example, the sequencing data of the test samples can be profiled using a whole genome panel, a whole exome panel, or a targeted resequencing panel for a predetermined portion of one of the genome or the exome. Systems and methods disclosed herein can generate a model of inherent noise due to the protocols used to obtain the sequencing data. For example, the model can correspond to noise likely arising from technical variability in storage and processing of biological samples, DNA capture, hybridization and/or amplification as well as variability in sequencing platforms. The model can establish chromosome-specific thresholds estimating variability associated with the inherent noise to detect CNAs. The noise model thus can provide noise thresholds for respective chromosomes to effectively filter out inherent noise arising from the protocols used to obtain the sequencing data. The approach disclosed herein can effectively model noise in a manner that is both platform-agnostic and sample-agnostic, thereby demonstrating its global applicability and utility.

The noise model can be applied to sequencing data to detect CNAs, such as for use in a clinical setting (e.g., for diagnosis, monitoring, or the like of a disease in a patient) and/or a research setting (e.g., for studying the CNAs related to a disease in one or more population groups). In the clinical setting, the systems and methods can compare a noise model constructed from a comparison of normal samples to the test (or disease) sample to detect the CNAs. The CNAs can be used, for example, in a tumor biopsy. In the research setting, the systems and methods can compare a noise model constructed from a comparison of control samples to the population of test sample to detect the CNAs.

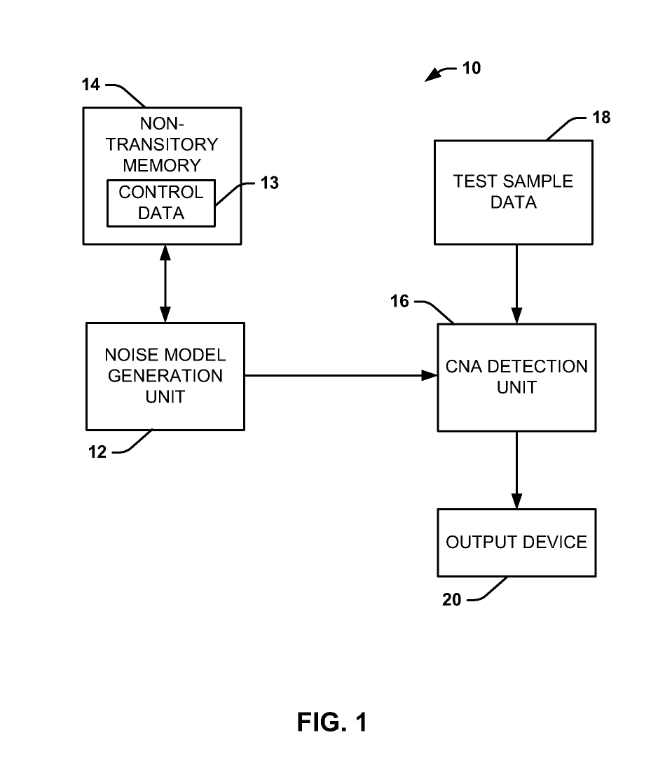

FIG. 1 illustrates an example of a system 10 that can detect copy number alterations (CNA) in test sample data 18, which can include sequencing data for one or more test samples. The system 10 can utilize a noise model generated based on control data 13 to detect the CNAs in the test sample data 18. The system 10 can detect CNAs in the test sample data 18 in a manner that does not require the manual assignment of one or more non-intuitive parameters like traditional techniques. Therefore, the system 10 does not suffer from significant variability in the CNAs detected between users (e.g., clinicians or researchers) exhibited with use of the traditional techniques. The system 10 can be data-driven, requiring no a priori assumptions of the sequencing measurements, therefore eliminating the need for user-assigned parameters and limiting the variability across users, platforms, and application contexts. As an example, the samples (the control data 13, the test sample data 18 or both) can be frozen samples or formalin-fixed paraffin-enabled (FFPE) samples, which generally include partially-degraded or limited genomic material. In addition to sequencing protocol itself, the storage and processing of the physical samples, including control samples and test samples, can introduce noise (e.g., variability) into the sequencing data 13 and 18.

The system 10 can include a noise model generation unit 12 and a CNA detection unit 16 that can operate in conjunction to detect the CNAs in the one or more test samples 18. The noise model generation unit 12 and the CNA detection unit 16 can be embodied in one or more computing devices (e.g., servers, generalized computing device, or the like) that include at least one non-transitory memory and at least one processing resource (e.g., a processor, a processing core, or the like). The non-transitory memory 14 can store computer readable instructions and data. The processing resource can access the memory for executing computer readable instructions, such as for performing the functions and methods of the model generation unit 12 and the CNA detection unit 16 described herein.

The noise model generation unit 12 can be programmed to generate a noise model based on control data 13 stored in a non-transitory memory 14 to represent inherent noise detected in control samples. For example, the noise model can represent chromosome-specific noise levels inherent in a common set of protocols used to obtain the control data 13 and the test sample data 18. The set of protocols can include storage and handling of samples as well as sequencing protocols used to generate the data from respective samples. The memory 14 can be external to the noise model generation unit 12 or implemented within the noise model generation unit 12. The noise model generation unit 12 can pass the noise model to the CNA detection unit 16, which can use the noise model to detect CNAs in test data from at least one test sample 18. The CNA detection unit 16 can output data related to the CNAs in the test data to an output device 20, which can display information related to the CNAs in the test data to a user of the output device 20 (e.g., a clinician or a researcher). The information can include, for example, a probability score (e.g., a p value) for each CNA determined from the test data 18. In some examples, the output device 20 can be a monitor, a GUI, a display, a printer, a speaker, or other device that can render the output in a tangible form comprehensible by the user.

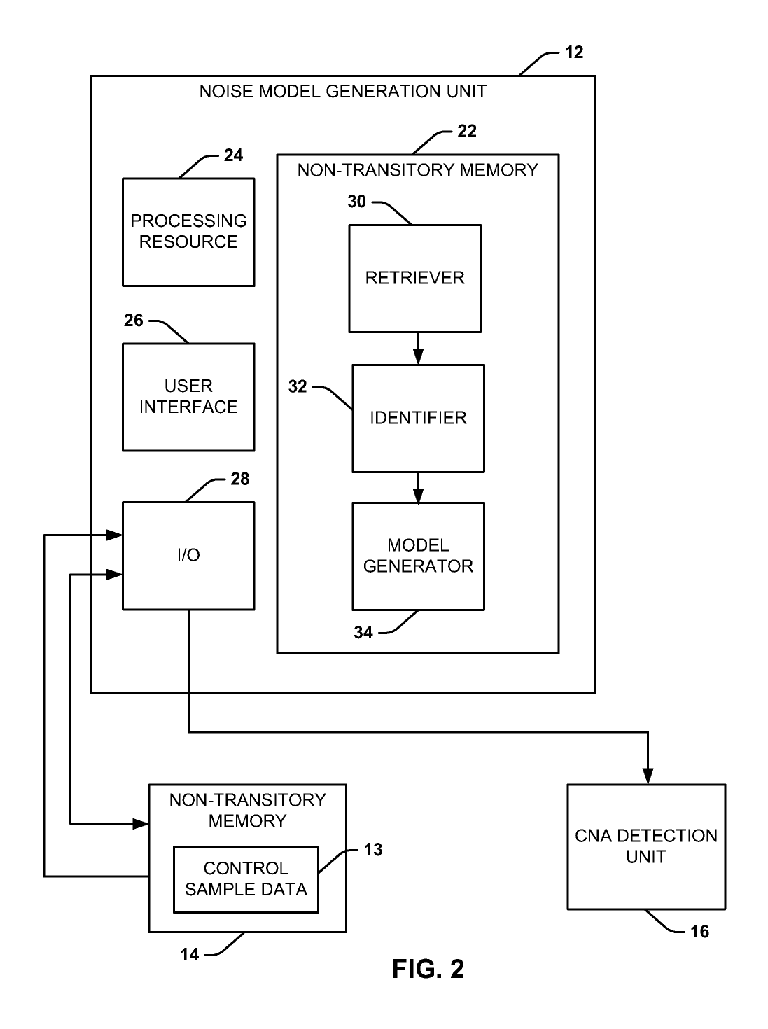

An example of the noise model generation unit 12 is shown in FIG. 2. The noise model generation unit 12 can include a non-transitory memory 22, a processing resource 24, a user interface 26, and an input/output (I/O) 28. The non-transitory memory 22 can store data and machine-readable instructions. The processing resource 24 can access the non-transitory memory and execute the machine-readable instructions. The user interface 26 can enable user inputs with respect to the noise model generation unit 12. The user inputs can, for example, be used to select one or more of the control sample data 13 from the (local or remote) non-transitory memory 14 for the generation of the noise model. As another example, the user inputs can be used for filtering and setting specific confidence intervals. The I/O unit 28 can interface with the (local or remote) non-transitory memory 14 to access the control sample data 13 and provide the noise model to the CNA detection unit 16. In some examples, the noise model can be stored in the memory 22 and accessed by the CNA detection unit 16. The CNA detection unit 16 can be implemented as executable instructions residing in the same or different memory 22.

The machine-readable instructions of the noise model generator 12 can include a retriever 30, an identifier 32, and a model generator 34. The retriever 30 can access the (local or remote) non-transitory memory 14 (e.g., via the I/O 28) to retrieve control sample data 13 corresponding to sequencing data of a plurality of control samples. In some examples, the control sample data 13 can represent sequencing data normal biological samples (e.g., not exhibiting a certain disease). In other examples, the control sample data 13 can represent control samples exhibiting similar or the same characteristics of a certain phenotype. As disclosed herein, the control sample data 13 can include sequencing data obtained via a common protocol (e.g., using a whole genome panel, a whole exome panel, or a targeted resequencing panel for a predetermined portion of one of the genome or the exome).

The identifier 32 can analyze comparisons between respective chromosomes of control sample data 13 (e.g., normal-normal comparisons or control-control comparisons) to determine an indication of noise (e.g., noise thresholds) associated with each of the chromosomes in the sequencing data that is inherent in the protocol (e.g., associated with sampling, storage and sequencing of DNA material). The model generator 34 can generate the noise model representing the indication of noise associated with each of the chromosomes, as represented in the control sample data.

For example, the model generator can implement the model using the generalized extreme value distribution (GEV), which can correspond to the chromosome-specific thresholds that can be stored in memory for use in detecting CNAs. The model generator 34 can output (through I/O 28) the generated noise model for use by the CNA detection unit 16.

The CNA detection unit 16 can use the noise model to detect CNAs in test data for one or more test samples obtained via the common protocol for which the model was generated. Since the model is specific to a given workflow protocol that is used to produce sequencing data, which can include harvesting and storage of biological samples and processing of samples to generate sequencing data, different models can be provided for different sequencing laboratories. Where different test sample sequencing data have been obtained via different protocols, respective instances of the noise model generation unit 12 can be implemented to generate a noise model to establish corresponding noise thresholds for each respective protocol.

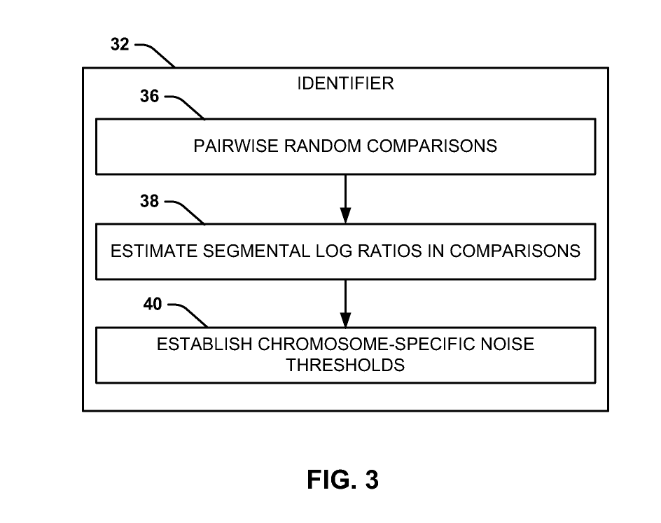

An example of operations performed by the identifier 32 is shown in FIG. 3. The identifier 32 can perform pairwise random comparisons (e.g., normal-normal or control-control), at element 36. The pairwise comparisons can be comparisons of the same chromosomes from different normal samples. Based on the comparisons, at element 38, the identifier 32 can estimate segmental log ratio values for a plurality of segments. The segmental log ratio values can be used to correlate the comparisons. At element 40, the identifier 32 can establish chromosome-specific noise thresholds for each of a plurality of chromosomes in the compared data based on the segmental log ratios. For example, the estimated segmental log ratio values can be based on a determined entropy threshold for each chromosome based on an evaluation of an entropy of the free distribution for each respective chromosome. A coverage threshold can them be determined for each chromosome based on an evaluation of a fraction of windows having a non-zero frequency across sample pairs. The noise thresholds can account for different types of variability in the data. For example, the noise thresholds can be determined based on the entropy threshold and/or the coverage threshold determined for each respective chromosome and can account for sample-to-sample technical variability and/or platform-specific technical variability.

Referring back to FIG. 2, the model generator 34 can generate the noise model by computing a probability distribution representing each of the chromosome-specific noise thresholds. For example, the model generator 34 can estimate generalized extreme value distribution parameters and generate the noise model based on the estimated extreme value distribution parameters. The model generator 34 can compute the noise model by calculating the probability distribution representing each of the chromosome specific noise thresholds, such as by estimating generalized extreme value distribution parameters thereof. The noise model, thus, can correspond to the set of estimated extreme value distribution parameters. Additionally, the generalized extreme value distribution parameters can be estimated for copy number amplifications as well as for copy number deletions. The resulting noise model define chromosome-specific thresholds that account for one or more of sample-to-sample technical variability as well as or platform-specific technical variability (e.g., specific to the manner samples are stored and handled as well as sequencing data is generated from the samples).

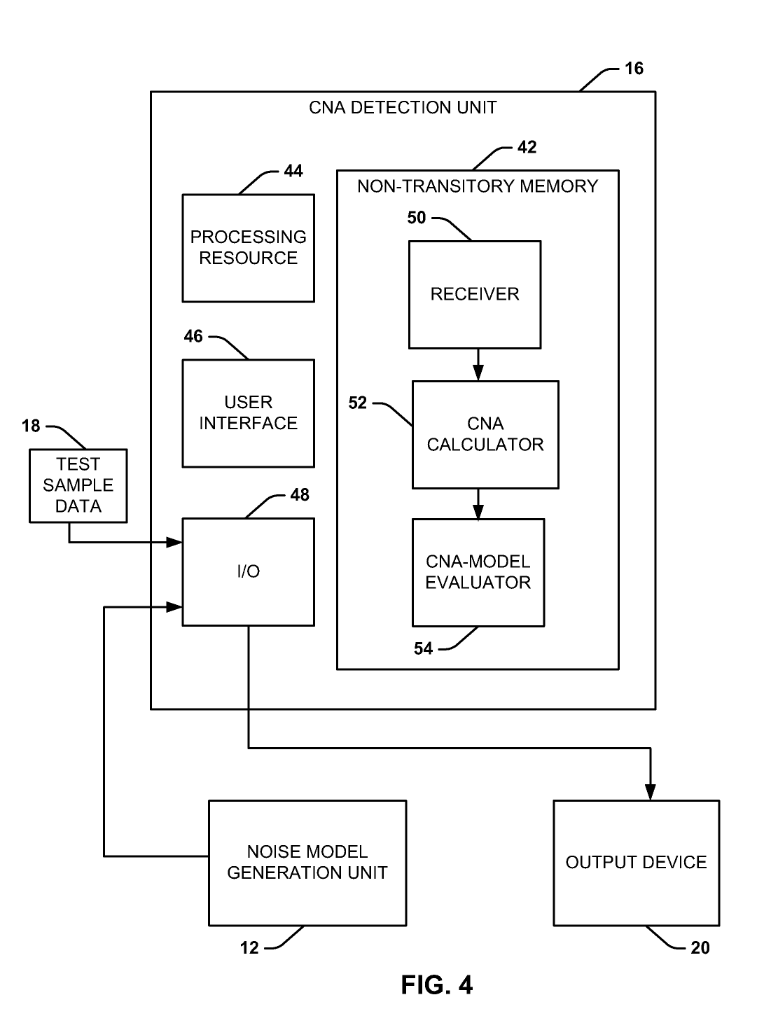

The noise model generation unit 12 can store the noise model in memory for use by the CNA detection unit 16, an example of which is shown in FIG. 4. The CNA detection unit 16 is configured to employ the parameters established by the noise model to detect CNAs in sequencing data produced according to a common protocol used to produce the sequencing data (control data) that was used to generate the noise model. The CNA detection unit 16 can include a non-transitory memory 42, a processing resource 44, a user interface 46, and an input/output (I/O) 48. The non-transitory memory 42 can store data and machine-readable instructions. The data can include one or more noise model produced by the noise model generation unit 12. The processing resource 44 can access the non-transitory memory and execute the machine-readable instructions. The user interface 46 can enable user inputs to and outputs from the CNA detection unit 16. The user inputs can, for example, be used to select or set a confidence interval for the detected CNAs. Additionally, the user interface can be used to specify a location for test sample data 18, which can be stored locally or remotely from the CAN detection unit 16. The I/O 48 can interface with the noise model generation unit 12 to receive the noise model. The I/O unit 48 can also receive the test sample data 18 (e.g., a user input or machine input of results of a medical test, such as a patient's tumor biopsy). The I/O unit 48 can also interface with the output device 20 to communicate an output related to the CNAs. For example, the output can include data representing detected CNAs for one or more test samples, and a confidence interval associated with each of the detected CNAs.

The machine-readable instructions can include at least a receiver 50, a CAN calculator 52, and a CNA-model evaluator 54. The receiver 50 can be configured to receive the test sample data 18 (e.g., from memory) using the I/O 48. In some examples, the test sample data 18 can represent sequencing data generated (e.g., in-house or by a third party DNA sequencing laboratory) from a patient sample (e.g., a tumor biopsy or other medical test). In other examples, the test sample 18 can represent sequencing data from a plurality of patients (e.g., for research regarding a population). Additionally, the test sample data 18 can include sequencing data for each sample obtained via a common protocol (e.g., using a whole genome panel, a whole exome panel, or a targeted resequencing panel for a predetermined portion of one of the genome or the exome).

The CNA calculator 52 is configure to compare the test sample data 18 with respect to normal sequencing data to identify potentially copy-number altered segments. Again, the test sample data 18 and the normal sequencing data correspond to sequencing data obtained via a common protocol. As mentioned, the common protocol corresponds to the protocol used to produce sequencing data from which the noise model has been generated. The CNA calculator is configured to identify CNAs in the test sample based on the comparing, such as to provide estimation of segmental LogRatios for each sample-normal comparison. The comparing can eliminate variations and artifacts due to data collection or between samples. For example, the CNA-model evaluator 54 can employ the model with respect to the segmental Log Ratios to evaluate the probability whether candidate CNAs are due to inherent noise. The evaluator 54 can communicate statistics (e.g., p values) and other information for the identified CNAs to an output device 20 through the I/O 48. The output device 20 can provide output data and other information (e.g., confidence intervals) related to the identified CNAs in the test sample.

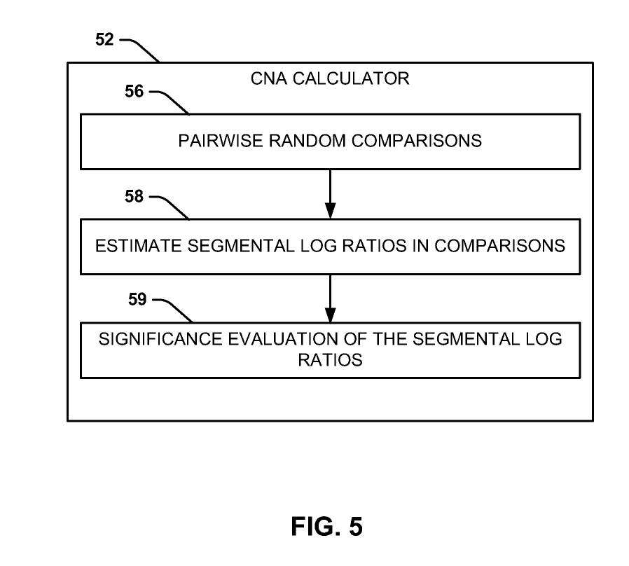

FIG. 5 shows an example of operations that can be performed by the CNA calculator 52. The CNA calculator 52, at element 56, can perform comparisons (disease-normal or test-control) in a comparison between the test sample 18 to ascertain a preliminary indication of variations in copy number. At 58, segmental Log Ratios are estimated for each of the comparisons, such as to provide estimated segmental Log Ratio values for each disease-normal comparison. For example, the comparisons at 56 can include read depth comparisons and circular binary segmentation can be employed at 58 to estimate segmental LogRatios for each disease-normal comparison. It is to be appreciated that the disease-normal samples may be matched samples. In other examples, the CNA calculator 52 can be implemented for reliably detecting CNAs in disease samples (e.g., tumors) even in the absence of a matched normal sample. That is, the approach disclosed herein does not require matched-normal samples since the noise model is agnostic to the platform and tissue samples being used. Additionally, the CNA detection unit can reliably determined CNAs irrespective of tumor content (e.g., results are independent of the purity of the tumor content). As mentioned, separate segmental LogRatios can be determined for copy number deletions and copy number amplifications. In some examples, GC base correction and distribution adjustments can also be implemented to mitigate associated error.

At 59, the significance of the segmental log ratios can be evaluated with respect to the noise model. For example, the estimated segmental log ratio values for each of the plurality of chromosomes can be evaluated with respect to the chromosome-specific noise thresholds defined by the noise model. The noise model can provide chromosome-specific thresholds to remove variability in the estimated CNAs due inherent noise. The CNAs can be identified at 59 based on applying the noise model (e.g., based on EVD distribution) to the segmental LogRatios to compute a probability of CNAs to indicate whether the CNAs correspond to noise or due actual additions or deletions. For example, the significance of the estimated segmental log ratios having positive values with respect to the chromosome-specific extreme value distribution parameters for copy number amplifications can be used to determine copy number amplifications. Similarly, the significance of the estimated segmental log ratio having negative values with respect to the chromosome-specific extreme value distribution parameters can be used to determine copy number deletions.

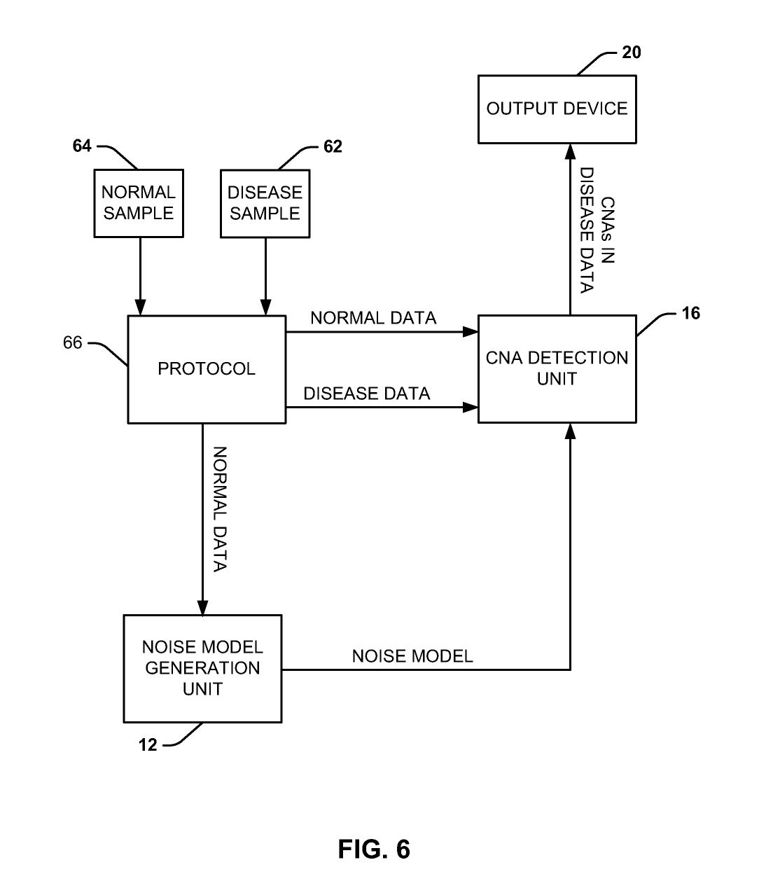

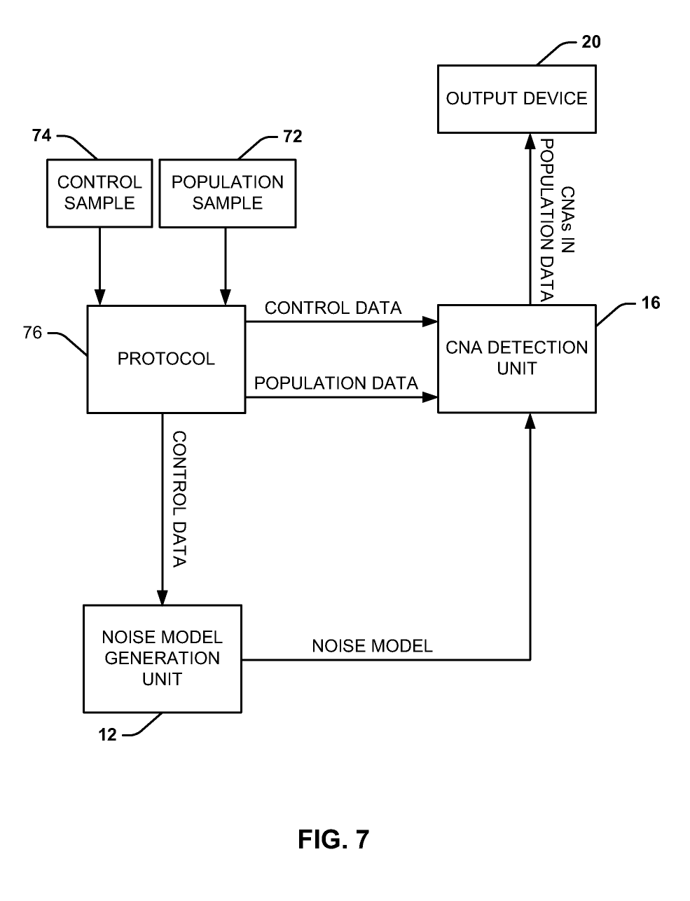

FIGS. 6 and 7 show examples of some possible different uses of system 10. FIG. 6 shows the system 10 being used in a clinical setting (for a single patient, such as a tumor biopsy), while FIG. 7 shows the system 10 being used in a research setting (for a population of patients). The data produced from the normal sample 64 or the control sample 74 and the disease sample 72 or the data obtained for the population sample 72 can be produced using a protocol 66, 76. As an example, the protocol can include preparation and handling of tissue samples, and can include use freezing or FFPE, which can affect and, in some cases, cause damage to the sample. Advantageously, the noise model generated according to the approach disclosed herein can characterize the level of noise/damage resulting from FFPE, freezing or other tissue preparation methods for the sample under test.

As another example, the protocol 66, 76 can profile the data according to a whole genome panel, a whole exome panel, or a targeted resequencing panel for a predetermined portion of one of the genome or the exome. In either the example of FIG. 6 or FIG. 7, the detected CNAs can be further analyzed to attribute the CNAs to a given disease, as a diagnostic for a given patient or a given population as the case may be. As another example, the detected CNAs can be used to determine novel diagnostic, prognostic and/or theranostic biomarkers as well as potential targets for therapeutic intervention. In the diagnostic case, for example, a potential diagnosis can be output based on the identified CNAs along with a probability of the potential diagnosis (e.g., a percent probability, a confidence interval, or the like).

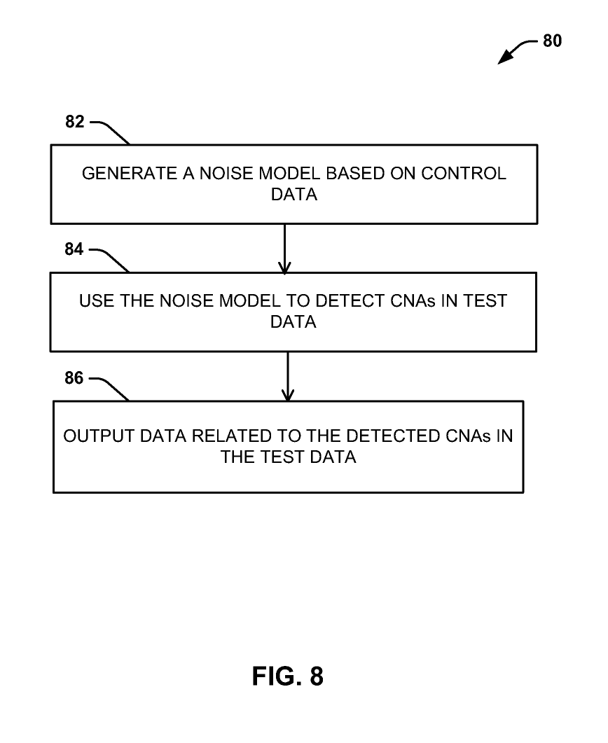

In view of the foregoing structural and functional features described above, example methods will be better appreciated with reference to FIGS. 8-10. While, for the purposes of simplicity of explanation, the example methods of FIGS. 8-10 are shown and described as executing serially, the present examples are not limited by the illustrated order, as some actions could in other examples occur in different orders and/or concurrently from that shown and described herein. Moreover, it is not necessary that all described actions be performed to implement a method. The method can be stored in one or more non-transitory computer-readable media and executed by one or more processing resources, such as disclosed herein. The method can be implemented on a computer locally or remotely via a service accessed through a network connection.

FIG. 8 illustrates an example of a method 80 that employs a noise model to detect and identify CNAs in one or more test samples (e.g., from a single patient or from a population of patients). For example, method 80 can be executed by a system (e.g., the system shown in FIG. 1) that can include a non-transitory memory that stores machine executable instructions and a processing resource to access the non-transitory memory and execute the instructions to cause a computing device to perform the method 80.

At 82, a noise model can be generated (e.g., by noise model generation unit 12) based on control data (e.g., from previously-collected biological data). At 84, the noise model can be used (e.g., by CNA detection unit 16) to detect CNAs in the test data. At 86, the CNAs in the test data (and/or additional data related to the CNAs, such as confidence intervals) can be output (e.g., by an output device 20). In some examples, information corresponding to the confidence intervals can be selected by a user (e.g., clinician or researcher) and entered into the noise model generation unit 12 or the CNA detection unit 16.

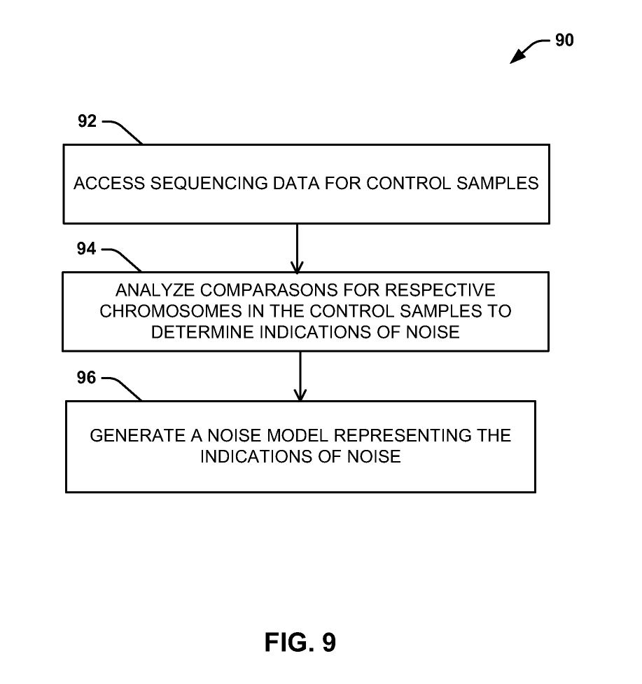

FIG. 9 illustrates a method 90 to generate a noise model, such as corresponding to the operation of the noise model generation unit 12. At 92, sequencing data for normal samples (or control samples) can be accessed. At 94, normal-normal comparisons can be analyzed for respective chromosomes in the normal samples to determine indications of noise. The noise can be inherent noise due to protocol, which can include noise due to handling and storage of samples as well as the data collection/sequencing procedures utilized to generate the sequencing data that is being processed. At 96, the resulting noise model is generated and stored in non-transitory memory to represent the determined indications of noise. For example, the noise model can represent variability in chromosome-specific noise corresponding to the protocol.

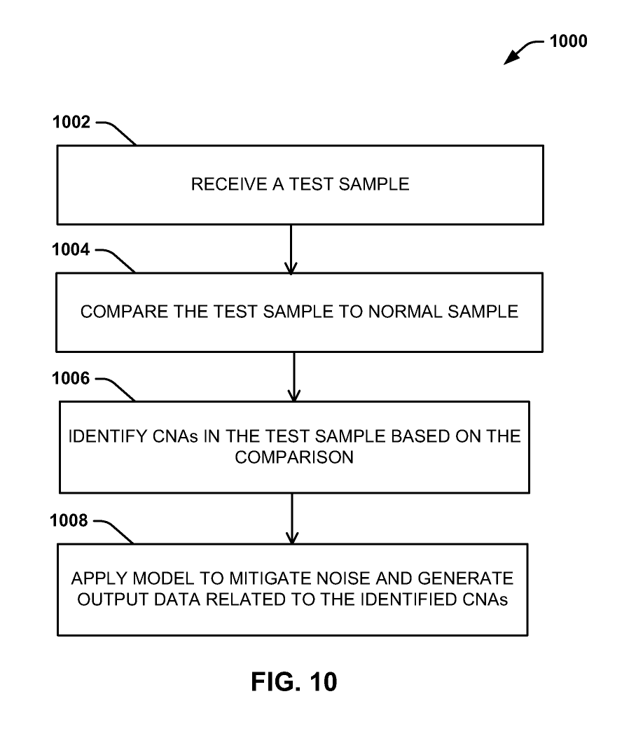

FIG. 10 illustrates a method 1000 for operation of the CNA detection unit 16. At 1002, test sample data is received (e.g., population samples or a disease sample). Normal sequencing data is also received. The test sample data represents sequencing data that was produced according to a protocol that is common to the protocol utilized to generate a corresponding noise model (FIG. 9). At 1004, the test sample can be compared to the normal sequencing data. For example, chromosomes of the test sample can be compared to normal sequencing data (e.g., a pairwise comparison) to determine variations for respective chromosome pairs. At 1006, CNAs can be identified in the test sample based on the comparison. At 1008, the noise model (e.g., generated for a common protocol as used to produce the test sample data) is applied to mitigate noise and generate output data related to the identified CNAs (e.g., by output device 20). The output data can include an indication of the CNAs and a confidence interval associated with the CNAs can be included in the output.

In view of the foregoing structural and functional description, those skilled in the art will appreciate that portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims.

Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on” means based at least in part on.

What is claimed is:

1. A method comprising:
accessing, by a system comprising a processor, control sequencing data stored in a non-transitory memory for a plurality of normal biological samples, the control sequencing data for each of the biological samples being obtained via a common protocol;
comparing, by the system, each of a plurality of chromosomes within the control sequencing data to determine associated indications of noise that is inherent in the common protocol used to produce the control sequencing data;
generating, by the system, a noise model representing the inherent noise associated with each of the plurality of chromosomes; and
using the noise model to detect copy number alterations (CNAs) in sequencing data for at least one test sample obtained according to the protocol.

2. The method of claim 1, further comprising outputting the detected CNAs and respective associated confidence intervals.

3. The method of claim 1, wherein the comparing each of the plurality of chromosomes within the sequencing data further comprises determining noise thresholds for each of the plurality of chromosomes, the noise thresholds accounting for one or more of sample-to-sample technical variability and platform-specific technical variability of the protocol.

4. The method of claim 1, wherein the control sequencing data comprises sequencing data for the plurality of biological samples profiled using the at least one of a whole genome panel, a whole exome panel, and a targeted resequencing panel for a predetermined portion of one of the genome or the exome.

5. The method of claim 1, wherein the comparing each of the plurality of chromosomes within the sequencing data further comprises:
estimating segmental log ratio values for a plurality of segments to correlate the noise in the comparisons;
establishing a chromosome specific noise threshold for each of the plurality of chromosomes based on the segmental log ratios; and
wherein the generating the noise model further comprises computing a probability distribution representing each of the chromosome specific noise thresholds.

6. The method of claim 5, wherein the computing the probability distribution further comprises estimating extreme value distribution parameters, wherein the noise model is generated from the estimated extreme value distribution parameters.

7. The method of claim 5 further comprising:
separating the plurality of segments into two groups according to the log ratio values;
wherein the estimating the segmental log ratio values further comprises:
for one of the two groups, estimating value distribution parameters for copy number amplifications; and
for another of the two groups, estimating value distribution parameters for copy number deletions.

8. The method of claim 5, wherein the evaluating the estimated log ratio values further comprises:
determining an entropy threshold for each chromosome based on an evaluation of an entropy of a frequency distribution for each respective chromosome; and
determining a coverage threshold for each chromosome based on an evaluation of a fraction of windows having non-zero frequency across sample chromosome pairs,
wherein the chromosome specific noise threshold for each chromosome is determined based on the entropy threshold and/or the coverage threshold determined for each respective chromosome.

9. A system comprising:
a non-transitory memory storing machine-readable instructions; and
a processing unit to access the non-transitory memory and execute the machine-readable instructions, the machine-readable instructions comprising:
a retriever to access sequencing data stored in the non-transitory memory for a plurality of biological samples, the sequencing data for each of the biological samples being obtained via a common protocol;
an identifier to compare a plurality of chromosomes within the sequencing data to determine an indication of noise associated with each of the plurality of chromosomes that is inherent in the common protocol used to obtain the sequencing data; and
a model generator to generate a noise model representing the indication of noise associated with each of the plurality of chromosomes,
wherein the noise model is used to detect copy number alterations (CNAs) within test sequencing data obtained via the protocol by analyzing variability thereof with respect to the noise model.

10. The system of claim 9, wherein the identifier is further to determine noise thresholds for each of the plurality of chromosomes, the noise thresholds accounting for one or more of sample-to-sample technical variability and platform-specific technical variability of the protocol.

11. The system of claim 9, wherein the identifier is further to:
estimate segmental log ratio values for a plurality of segments to correlate the noise in the comparisons;
evaluate the estimated segmental log ratio values to establish chromosome specific noise thresholds for each of the plurality of chromosomes; and
wherein the model generator is to generate the noise model by computing a probability distribution representing each of the chromosome specific noise thresholds.

12. The system of claim 11, wherein the model generator is to compute the probability distribution by estimating generalized extreme value distribution parameters for each chromosoe, wherein the noise model is generated from the estimated extreme value distribution parameters.

13. The system of claim 11, wherein the identifier is further configured to evaluate the estimated log ratio values by:
determining an entropy threshold for each chromosome based on an evaluation of an entropy of a frequency distribution for each respective chromosome; and
determining a coverage threshold for each chromosome based on an evaluation of a fraction of windows having non-zero frequency across sample chromosome pairs,
wherein the chromosome specific noise threshold for each chromosome is determined based on the entropy threshold and/or the coverage threshold determined for each respective chromosome.

14. A method comprising:
receiving at least one test sample;
comparing, by a system comprising a processor, the at least one test sample to a noise model constructed based on sequencing data from a plurality of biological samples obtained via a common protocol, wherein the noise model identifies noise associated with each of a plurality of chromosomes in the sequencing data that is inherent in the protocol used to obtain the sequencing data;
identifying, by the system, copy number alterations (CNAs) in the at least one test sample based on the comparing; and
outputting, by the system, data related to the identified CNAs in the at least one test sample.

15. The method of claim 14, wherein the comparing further comprises:
estimating segmental log ratio values by comparing the data from the at least one test sample and the noise model for each of the plurality of chromosomes; and
comparing the estimated segmental log ratio values for each of the plurality of chromosomes with respect to respective chromosome-specific noise thresholds defined by the noise model.

16. The method of claim 14, wherein the comparing further comprises:
estimating segmental log ratios by comparing the at least one test sample to the sequencing data for each of the plurality of chromosomes;
evaluating a significance of the estimated segmental log ratios having positive values with respect to chromosome-specific extreme value distribution parameters determined for copy number amplifications; and
evaluating a significance of the estimated segmental log ratio having negative values with respect to chromosome-specific extreme value distribution parameters determined for copy number deletions.

17. The method of claim 14, further comprising identifying at least one target gene in the at least one test sample based on determining a high frequency of CNAs for the at least one target gene.

18. The method of claim 14, further comprising:
analyzing, by the system, the detected CNAs with respect to at least one given disease;
determining, by the system, at least one likelihood value corresponding to a given disease based on the analyzing; and
outputting, by the system, the at least one likelihood value corresponding to the given disease,
wherein the at least one given disease is a type of cancer.

19. A system comprising:
a non-transitory memory storing machine-readable instructions;
a processing unit to access the non-transitory memory and execute the machine-readable instructions, the machine-readable instructions comprising:
a receiver to receive test sequencing data for at least one test sample;
a calculator to estimate segmental LogRatios from pairwise disease-normal comparisons of segments of the test sequencing data produced from at least one disease sample and normal biological samples obtained according to a common protocol; and
an evaluator to identify copy number alterations (CNAs) in the test sequencing data of the disease sample based on applying a noise model with respect to the estimated segmental LogRatios, the noise model characterizes chromosome-specific noise thresholds associated with each of a plurality of chromosomes that is inherent in the protocol used to obtain the test sequencing data; and
an output device to provide output data related to the identified CNAs in the test sequencing data.

20. The system of claim 19, wherein the disease sample is a tumor sample, and the calculator identifies specify tumor-specific somatic CNAs.

21. The system of claim 20, wherein the calculator is further configured to:
estimate segmental log ratios by comparing tumor sequencing data and normal sequencing data for each of the plurality of chromosomes;
evaluate a significance of the estimated segmental log ratios having positive values with respect to chromosome-specific extreme value distribution parameters for copy number amplifications to determine tumor-specific somatic copy number amplifications; and
evaluate a significance of the estimated segmental log ratio having negative values with respect to chromosome-specific extreme value distribution parameters for copy number deletions to determine tumor-specific somatic copy number deletions.

22. The system of claim 19, further comprising a user interface to set a confidence value in response to a user input, the confidence value being employed by the evaluator in identifying the CNAs.
